(19) United States
(12) Patent Application Publication
(10) Pub. No.: US 2009/0035440 A1
(43) Pub. Date: Feb. 5, 2009

(54) Compositions comprising polyphenol

(75) Inventor: Krassimir Petkov Velikov, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/221,020

(22) Filed: Jul. 30, 2008

(30) Foreign Application Priority Data
Aug. 2, 2007 (EP) EP07113664

(51) Int. Cl. A23L 1/305; C08G 73/02; C08L 89/00; A23J 1/00; A23G 3/44; A23F 3/00; C08B 37/00; C08F 26/00

(52) U.S. Cl. 426/597; 525/540; 525/54.1; 525/54.3; 525/132; 525/417; 426/656; 426/590; 426/660; 426/657

(57) ABSTRACT

The present invention provides a composition comprising polyphenol and polymer comprising amine groups, wherein at least 0.1% polyphenol by weight of the composition is present as part of a complex with the polymer, and wherein the complex is in the form of particles. Also provided are uses of polymers comprising amine groups for controlling the properties of polyphenol and a method of manufacturing a composition comprising a complex of polyphenol and polymer.

### TECHNICAL FIELD OF THE INVENTION

The present invention relates to compositions comprising polyphenol. In particular the present invention relates to the use of polymers comprising amine groups for providing improved compositions comprising polyphenol.

### BACKGROUND OF THE INVENTION

Natural polyphenols can be found in many plants and are believed to be responsible for many characteristics of plant-derived foods and beverages, particularly colour and taste properties. They are also reported to contribute to the health benefits associated with consumption of diets high in fruits and vegetables or plant-derived beverages (such as tea and wine). They have synthetic, medicinal and industrial value (for example as antioxidants, antimicrobials, pigments and/or UV-absorbers). Naturally occurring polyphenols are known to have numerous biological activities. They are found to be potential candidates for use in treating or preventing diseases as diverse as heart ailments, ulcer formation, bacterial infection, mutagenesis and neural disorders. Thus there is a demand for products with high level of polyphenols.

Unfortunately, providing products with high levels of polyphenols is challenging owing to strong interactions of polyphenols with other ingredients in the product composition. For example it is known that polyphenols form complexes with certain polymers to give unwanted haze in beverages (see, for example, K. J. Siebert and P. Y. Lynn, “Effect of Protein-Polyphenol Ratio on the size of Haze Particles”, Journal of the American Society of Brewing Chemists, 2000, 58(3), pp. 117-123). In addition polyphenols generally have poor oxidation stability, interact with metal ions, have poor polymerisation stability, and strong impact on product sensory characteristics. In particular, polyphenols are often found to provide unwanted astringency and bitterness to food compositions, reducing the palatability thereof, and are often highly coloured in solution and so bring unwanted colouring to some products.

Previous attempts have been made to provide improved compositions comprising polyphenol. For example, N. Hayashi et al. (“Reduction of Catechin Astringency by the Complexation of Gallate-Type Catechins with Pectin”, Biosci, Biotechnol. Biochem., 2005, 69(7), pp. 1306-2101) have reported that the astringency of gallate-type catechins was reduced by complexation with pectin.

It has also been suggested that complexation of polyphenols by casein proteins is primarily responsible for the reduction of bitterness when milk is added to tea (G. Luck et al., “Polyphenols, Astringency and Proline-Rich Proteins”, Phytochemistry, 1994, 37(2), pp. 357-371). This effect has primarily been attributed to the highly specific structure present in casein micelles.

We have now found that some of the interactions of polyphenols which have previously been considered as undesirable can be effectively used to provide improved product properties. In particular we have found that complexation of polyphenol with a certain class of polymer (including some of those responsible for haze in beverages) surprisingly allows for the incorporation of polyphenols in products at high levels with minimum impact on product sensory properties and/or increased stability of the polyphenol in the product.

Tests and Definitions

Polyphenol

As used herein, the term “polyphenol” refers to one or more of a class compounds comprising a plurality of hydroxyl groups attached to one or more aromatic groups. The term “aromatic group” includes aromatic hydrocarbon groups and/or heterocyclic aromatic groups. Heterocyclic aromatic groups include those containing oxygen, nitrogen, or sulphur (such as those groups derived from furan, pyrazole or thiazole). Aromatic groups can be monocyclic (for example as in benzene), bicyclic (for example as in naphthalene), or polycyclic (for example as in anthracene). Monocyclic aromatic groups include five-membered rings (such as those derived from pyrrole) or six-membered rings (such as those derived from pyridine). The aromatic groups may comprise fused aromatic groups comprising rings that share their connecting bonds. The term polyphenol also includes glycosidic polyphenols and/or their derivatives (e.g. acids, esters, and/or ethers). Any combinations of the free and various esterified, etherified and glycosylated forms of polyphenols are also included. The polyphenol may be natural, synthetic or a mixture thereof. Typically the polyphenol will have a molecular weight of less than 10 kDa, more preferably less than 5 kDa and most preferably from 0.11 to 2 kDa.

Synthetic polyphenols include linear (open chain) and cyclic polyphenols and oligomers (see, for example, Handique J G, Baruah J B, “Polyphenolic compounds: an overview”, React. & Funct. Polym., 2002, 52(3), pp. 163-188).

Further examples of polyphenols include dopamine, epinephrine (adrenaline), norepinephrine (noradrenaline), salbutamol, curcumin and/or its derivatives, yakuchinone A, yakuchinone B, rosmarinic acid and/or its derivatives, paradol and its derivatives, hydroxytyrosol, silymarin, coumarin and/or its derivatives, esculetin, escopoletin, lignans (including sesamol, sesamin, sesamolin or mixtures thereof), carnosol, oleuropein, uric acid, ubiquinol, thymolphtaleine, phenolphthalein, carthamin, polyporic acid, atromentin, bovichinon-3, grevillin A, grevillin B, grevillin D, alkannin, shikonin, alizarin, purpurin, pseudopurpurin, purpuroxanthin, rubiadin, munjistin, chinizarin, morindon, emodin, aloe-emodin, rhein, chrysophanol, kermesic acid, flavokermesic acid, carminic acid, ellagic acid, spinochrome C, spinochrome D, spinochrome E, echinochrome A, red alkannin, hypericin, chrysophanic acid, betanidin, isobetanidin, pyrocatechol, pyrogallol, gallic acid and/or its esters, caftaric acid, chlorogenic acid, elonolic acid, protocatechuic acid, syringic acid, gentisic acid, caffeic acid, hops acids (including humulone, lupulone, colupulone or mixtures thereof), magnolol, honokiol, biphenols, di-resorcinol sulphide, bithionol, bromochlorophen, dioxybenzone, bisoctrizole, bemotrizinol, or a mixture thereof.

Preferred are natural polyphenols comprising a plurality of phenol groups per molecule. These polyphenols include tannins (such as tannic acid), phenylpropanoids, flavonoids or mixtures thereof. Most preferred are flavonoids as they are known to possess high biological activity. Suitable flavonoids include flavones (such as luteolin, apigenin, baicalin, tangeritin or a mixture thereof), flavonols (such as quercetin, galantin, kaempferol, myricetin, fisetin, isorhamnetin, pachypodol, rhamnazin, rutin, hydroxyethylrutosides or a mixture thereof), flavanones (such as hesperetin, naringenin, eriodictyol or a mixture thereof), 3-hydroxyflavanones (such as dihydroquercetin, dihydrokaempferol or a mixture thereof), isoflavones (such as genistein, daidzein, glycitein or a mixture thereof), neoflavonoids, flavan-3-ols (such as catechins, theaflavins or a mixture thereof), anthocyanidins (such as cyanidin, delphinidin, malvidin, pelargonidin, peonidin, petunidin or a mixture thereof), or a mixture thereof. Most preferred are catechins, theaflavins or a mixture thereof. Another preferred polyphenol is resveratrol which has been reported to have a number of beneficial health effects.

Polymer Comprising Amine Groups

The term “polymer comprising amine groups” refers to one or more polymers having a plurality of amine functionalities. The amine functionalities may be primary, secondary, tertiary, quaternary or a mixture thereof. Most preferred are polymers comprising heterocyclic amine groups. Heterocyclic amine groups include those derived from pyridine, piperidine, nitropyridine, aminopyridine, bromopyridine, pyrazine, pyridazine, pyrimidine, cytosine, thymine, uracil, quinoline, isoquinoline, niacin, saccharin, pyrrole, nitropyrrole, pyrrolidine, thiazole, imidazole, indole, histidine, proline, hydroxyproline, tryptophan, histidine, purine, histamine, aniline, caffeine or a mixture thereof.

Typically the polymer will have at least 3 amine functionalities, more preferably at least 10 and most preferably from 20 to 10000 per molecule. Additionally or alternatively, the polymer will have at least one amine functionality per monomer residue. The polymer will typically have a weight average molecular weight of at least 1 kDa, more preferably at least 5 kDa, most preferably from 10 to 1000 kDa.

The polymer comprising amine groups may be natural, synthetic or a mixture thereof. Suitable polymers include proteins other than casein (such as collagen, gelatine, elastin, prolamins, saliva proteins, whey proteins, soy proteins, their hydrosylates, their derivatives or a mixture thereof), polypeptides (such as poly-L-proline, poly-L-tryptophan, poly-L-histidine, or a mixture thereof), nucleic acids (such as DNA, RNA or a mixture thereof), synthetic polymers (such as poly(vinylpyridine), poly(vinylpirrolidone), polyaniline, polypyrrole or a mixture thereof), polysaccharides (such as chitosan, hyaluronan or a mixture thereof), or a mixture thereof. The most preferred prolamins are gliadin, zein or a mixture thereof. Other suitable polymers include melanins.

Complex

As used herein, the term “complex” refers to a non-covalent association of at least two molecules. A complex of polymer and polyphenol is typically one wherein the polyphenol is immobilised such that it is not detectable by high-resolution ¹H-NMR. A complex can usually be dissociated by addition of the solvent dimethyl sulfoxide (DMSO) in which case the polyphenol would become visible to high-resolution ¹H-NMR.

The weight ratio of polymer:polyphenol in the complex is preferably in the range of 100:1 to 1:100. However we have found that relatively small amounts of polymer can be used to complex the polyphenol, therefore the ratio is more preferably from 5:1 to 1:50 and most preferably 2:1 to 1:10.

Particle Size

As used herein, the term “particle size” refers to the maximum length of a particle in any dimension. Particles may be spherical, non-spherical or a mixture thereof. Thus, if a particle is spherical then the particle size refers to the diameter of the particle.

Beverage

As used herein the term “beverage” refers to a substantially aqueous drinkable composition suitable for human consumption. Preferably the beverage comprises at least 85% water by weight of the beverage, more preferably at least 90% and most preferably from 95 to 99.9%.

Tea Solids

As used herein, the term “tea solids” refers to dry material extractable from the leaves of the plant Camellia sinensis var. sinensis and/or Camellia sinensis var. assamica. The material may have been subjected to a so-called “fermentation” step wherein it is oxidised by certain endogenous enzymes that are released during the early stages of “black tea” manufacture. This oxidation may even be supplemented by the action of exogenous enzymes such as oxidases, laccases and peroxidases. Alternatively the material may have been partially fermented (“oolong” tea) or substantially unfermented (“green tea”).

Tea-Based Beverage

As used herein, the term “tea-based beverage” refers to a beverage comprising at least 0.01% by weight tea solids. Preferably the tea-based beverage comprises from 0.04 to 3%, more preferably from 0.06 to 2%, most preferably from 0.1 to 1%.

Catechins

As used herein the term “catechins” is used as a generic term for catechin, gallocatechin, catechin gallate, gallocatechin gallate, epicatechin, epigallocatechin, epicatechin gallate, epigallocatechin gallate, and mixtures thereof.

Theaflavins

As used herein the term “theaflavins” is used as a generic term for theaflavin, isotheaflavin, neotheaflavin, theaflavin-3-gallate, theaflavin-3′-gallate, theaflavin-3,3′-digallate, epitheaflavic acid, epitheaflavic acid-3′-gallate, theaflavic acid, theaflavic acid-3′-gallate and mixtures thereof. The structures of these compounds are well-known (see, for example, structures xi-xx in Chapter 17 of “Tea—Cultivation to consumption”, K. C. Willson and M. N. Clifford (Eds), 1992, Chapman & Hall, London, pp. 555-601).

Chocolate

As used herein the term “chocolate” refers to an edible composition comprising at least 5% by dry weight of material derived from the cacao tree (Theobroma cacao). The chocolate preferably comprises at least 10% by dry weight of material derived from the cacao tree, more preferably from 30 to 95% by dry weight. The chocolate is preferably at least semi-solid, more preferably it is solid at 20° C. The chocolate is preferably fat-continuous. The chocolate may be dark chocolate, milk chocolate or white chocolate.

### SUMMARY OF THE INVENTION

In a first aspect, the present invention provides a composition comprising:
polyphenol; and
polymer comprising amine groups, wherein the polymer is not casein;
   wherein at least 0.1% polyphenol by weight of the composition is present as part of a complex with the polymer, and wherein the complex is in the form of particles.

Such a composition delivers a high level of polyphenol in a form in which the polyphenols are relatively inert (i.e. in terms of taste, colour and/or stability) but which can be easily converted to an active form, for example by dissociation of the complex on ingestion.

In a further aspect the present invention provides use of a polymer comprising amine groups for reducing or eliminating bitterness and/or astringency of polyphenol, wherein the polymer is not casein.

In a still further aspect, the present invention provides a method of manufacturing a composition comprising a complex of polyphenol and polymer comprising amine groups, the process comprising the steps of:
i) mixing the polyphenol and polymer thereby to form a complex;
ii) recovering the complex; and then
iii) combining the complex with a supporting medium.

Such a process allows for manipulation of the properties of the complex independently of the supporting medium.

### DETAILED DESCRIPTION

The Composition

The composition comprises a high level of polyphenol stabilized by the complex. In particular, at least 0.1% polyphenol by weight of the composition is present as part of the complex, preferably at least 0.2%, more preferably at least 0.3% and most preferably at least 0.5% by weight of the composition. Typically, less than 50% polyphenol by weight of the composition is present as part of the complex, more preferably less than 10% and most preferably less than 2%.

The composition may also comprise polyphenol which is not part of a complex with the polymer. To minimize the impact of polyphenol on product properties, however, it is preferred that the majority of polyphenol in the composition is present as part of the complex. Thus preferably at least 50% by weight of the total amount of polyphenol in the composition is present as part of a complex with the polymer, more preferably at least 60%, more preferably still at least 80% and most preferably from 90 to 100%.

The total amount of polyphenol in the composition is preferably sufficient such that the composition can deliver an effective daily intake in one or two doses. Thus it is preferred that the composition is provided in a unit dose comprising at least 50 mg total polyphenol, more preferably at least 150 mg and most preferably from 300 mg to 1 g. For convenience of transport and handling it is preferred that the dose has a mass of less than 500 g, more preferably less than 250 g, more preferably still less than 200 g and most preferably from 20 to 150 g.

The complex is present in the composition in the form of particles. Smaller particles allow for incorporation of the complex with minimum impact on some product properties. Therefore it is preferred that at least 90% by weight of the particles have a particle size of less than 5000 nm, more preferably less than 1000 nm, 800 nm, 600 nm, 400 nm or even less than 200 nm. More preferably still at least 90% by weight of the particles have a particle size of from 10 to 100 nm.

Typically the particles will be dispersed in a supporting medium. Preferably the supporting medium will make up the bulk of the composition and determine, to a large extent, its sensory and physical characteristics. Thus it is preferred that the composition comprises the complex in an amount of less than 50% by weight of the composition, more preferably less than 10% and most preferably from 0.1 to 5%. The supporting medium may be any suitable substance and will depend to a large extent on the intended end use of the composition. Typically, however, the supporting medium will be a liquid, dispersion (single or duplex emulsion, foam or suspension), gel, solid, or a mixture thereof. The supporting medium may be aqueous (comprise at least 50% water by weight of the supporting medium) or non-aqueous. In a most preferred embodiment, the properties of the particles, especially their size and surface properties, and those of the supporting medium, especially its viscosity and polarity, are selected such that the particles form a stable colloidal dispersion in the supporting medium. The dispersion is preferably stable such that no appreciable sedimentation of the particles occurs over a period of at least 7 days at a storage temperature of 20° C., more preferably over a period of at least 1 month and most preferably at least 6 months.

The compositions of the present invention may comprise casein in addition to the polymer in the complex. However, it is preferred that the composition is substantially free from casein. In particular it is preferred that the composition comprises less than 0.1% casein by weight of the composition, more preferably less than 0.05% and most preferably less than 0.01%. This is because caseins may competitively interact with the polyphenol.

Pharmaceutical and Cosmetic Compositions

In one embodiment the composition is a pharmaceutical or cosmetic composition comprising a pharmaceutically and/or cosmetically acceptable vehicle.

The pharmaceutical and cosmetic compositions of the present invention may be suitable for any form of administration including oral, topical and/or intravenous administration. The form of the composition may, among others, be a tablet, pill, lozenge, paste, lotion, gel, cream, liquid (including emulsion and/or suspension), spray (including aerosol spray), foam or powder.

The pharmaceutical or cosmetic composition comprises a pharmaceutically or cosmetically acceptable vehicle which may act as a diluent, dispersant or carrier for the complex in the composition. The vehicle may be aqueous or anhydrous.

Water, when present, will be in amounts which may range from 5 to 99%, more preferably from 20 to 70%, optimally between 40 and 70% by weight of the composition.

Besides water, relatively volatile solvents may also be included within the vehicle. Most preferred are monohydric C1-C3 alkanols.

These include ethyl alcohol, methyl alcohol and isopropyl alcohol.

Emollient materials may also be included in the vehicle. These may be in the form of silicone oils and/or synthetic esters.

Humectants of the polyhydric alcohol type may also be employed in the vehicle. Typical polyhydric alcohols include glycerol, polyalkylene glycols and more preferably alkylene polyols and their derivatives.

Thickeners may also be utilized as part of the vehicle, as may sugars, plasticizers, antioxidants, antimicrobial agents, chelating agents, buffers, coloring agents, pigments, opacifiers, surfactants, propellants, flavours and/or perfumes.

Preferred cosmetic compositions are those suitable for application to human skin and preferably include a skin benefit agent in addition to the complex. Suitable skin benefit agents include anti-aging, anti-inflammatory, wrinkle-reducing, skin whitening, anti-acne, sunscreen (including UV-absorbing) and/or sebum reduction agents. Examples of these include alpha-hydroxy acids, beta-hydroxy acids, polyhydroxy acids, hydroquinone, t-butyl hydroquinone, vitamin B and C and their derivatives, micronised metal oxides, retinoids, betulinic acid, vanillic acid, allantoin, a placenta extract, hydrolactin, resorcinol derivatives, and mixtures thereof.

Food Compositions

A particularly preferred form of the composition is that of a foodstuff, as this allows for convenient and enjoyable consumption of the polyphenol. The food composition may be, for example, a margarine, low fat spread, confectionery product (such as chocolate or cereal bar), ice cream, dressing, mayonnaise, sauce, bakery product, shortening or cheese. It is especially preferred that the food composition is a beverage or a chocolate composition.

The food may be dried and contain less than 40% water by weight of the composition, preferably less than 25%, more preferably from 1 to 15%. Alternatively, the food may be substantially aqueous and contain at least 40% water by weight of the composition, preferably at least 50%, more preferably from 65 to 99.9%.

The food preferably comprises nutrients including carbohydrate (including sugars and/or starches), protein, fat, vitamins, minerals, phytonutrients (including terpenes, phenolic compounds, organosulfides or a mixture thereof) or mixtures thereof. The food may be low calorie (e.g. have an energy content of less than 100 kCal per 100 g of the composition) or may have a high calorie content (e.g. have an energy content of more than 100 kCal per 100 g of the composition, preferably between 150 and 1000 kCal).

The food may also contain salt, flavours, colours, preservatives, antioxidants, non-nutritive sweetener or a mixture thereof.

When the food composition is a beverage, it is preferably a coffee-based beverage, a tea-based beverage and/or a cocoa-based beverage. Most preferably the beverage is tea-based.

The pH of the beverage may, for example, be from 2.5 to 8, preferably 3 to 6, more preferably from 3.5 to 5.

When the food composition is chocolate, the composition may comprise theobromine (3,7-dihydro-3,7-dimethyl-1H-purine-2,6-dione) which is thought to contribute to the characteristic taste of chocolate and has certain physiological effects. It is especially preferred that the composition comprises at least 0.1%, more preferably at least 0.5% and most preferably from 1 to 5% theobromine by weight of the composition. When the food composition is a cocoa-based beverage, it may also comprise theobromine, more preferably the cocao-based beverage comprises from 0.05 to 1% by weight theobromine, most preferably from 0.1 to 0.4%.

White chocolate traditionally has a very low level of polyphenols owing to its low content of cocoa solids. We have recognized that by employing polyphenols in the form of the complex of the present invention, white chocolate can be prepared with the health benefits of darker chocolates without imparting unwanted bitterness to the white chocolate.

It is also envisaged that the chocolate composition of the invention may be employed as a filling, ingredient and/or coating for a confectionary product. For example, the chocolate may be used to coat ice confections (such as ice cream, sorbets, water ices and the like) and/or the chocolate may be dispersed within an ice confection.

Use of the Polymer or the Composition

The presence of a polymer comprising amine groups in compositions comprising polyphenol is found to reduce or eliminate the bitterness and/or astringency of the polyphenol. Although not wishing to be bound by theory we believe this may be due to the complex interfering with interaction between polyphenol and proteins and/or receptors in the mouth.

The polymer comprising amine groups may additionally or alternatively increase the oxidative stability of polyphenol, for example by making the polyphenol less available to interact with oxidizing agents and/or catalytic substances.

The polymer comprising amine groups may additionally or alternatively reduce or eliminate the colour of polyphenol. Without wishing to be bound by theory, we believe that association of the polyphenol with the polymer allows for increased light scattering which masks at least some of the colour of the polyphenol.

It is believed that each of the above uses is optimal when there are strong interactions between the polymer and polyphenol. Thus it is preferred that at least some of the polyphenol is present as a complex with the polymer. The complex is preferably in the form of particles as this minimises the impact of the complex on some other product properties, which it may be desirable to maintain. In a most preferred embodiment the uses set forth above employ the polymer as part of a composition according to the first aspect of the invention (including any specifically described embodiment of the composition).

The Method

The complexes and compositions according to the invention may be manufactured in any suitable manner. For example, the complex may be formed in-situ by contacting the polymer and polyphenol in a supporting medium.

However in a preferred embodiment the complex is manufactured independently of the supporting medium. This method comprises the steps of:
i) mixing the polyphenol and polymer thereby to form a complex;
ii) recovering the complex; and then
iii) combining the complex with a supporting medium.

The mixing in step (i) is preferably performed in a liquid medium, more preferably an aqueous liquid medium. The mixing is preferably performed under continuous stirring, especially if the complex is to be recovered as particles.

The recovery step (ii) usually involves separating the complex from a liquid medium, for example by drying, sedimentation, filtration or a mixture thereof. Drying may involve spray drying, freeze drying or a mixture thereof. In a most preferred embodiment the complex is recovered in step (ii) as particles, for example in the form of a powder or concentrated suspension. Step (ii) may additionally or alternatively include stabilization of the complex using surface active agents, polymers, sugars and/or protective colloids.

The combination step (iii) preferably comprises dispersing the complex, in the form of particles, in the supporting medium.

The method is particularly suitable for manufacturing the composition of the invention (including any specifically described embodiment of the composition) when the composition comprises a supporting medium as described hereinbefore.

### EXAMPLES

The present invention will now be illustrated by reference to the following non-limiting examples.

### Example 1

In this example, several candidate complexing agents (CAs) were assessed for the ability to bind polyphenol. Selected CAs were also tested for their ability to mask bitterness of polyphenol.

Materials

Epigallocatechin gallate (EGCG) was obtained form Roche, Switzerland. whey protein isolate (WPI) was purchased from Davisco, USA. Polyvinylpyrrolidone (PVP), L-proline and poly-L-proline were purchased from Sigma Chemicals (Schnelldorf, Germany). PVP was obtained in 3 molecular weight fractions: PVP 10 had an average molecular weight of 10 kDa, PVP 40 had an average molecular weight of 40 kDa and PVP 360 had an average molecular weight of 360 kDa. High Methoxy Pectin (HMP) (˜70% esterified) was obtained from CP-Kelco (San Diego, USA).

Sample Preparation

Stock solutions containing 1.2 wt % EGCG were prepared by adding the powder to de-ionized water (conductivity=18.2 MΩ.cm) and stirring at 40° C. Stock Solutions of PVP, WPI, L-proline and poly-L-proline, were each prepared by dissolving in de-ionized water 25° C. to give a concentration of 1.2 wt %. Stock solutions of pectin, were prepared by dissolving powder in de-ionized water at 80° C. for 1 hour and then cooling to 25° C. After dissolving the material, the pH of all samples, except for the WPI, was adjusted to 5.0 using 0.01 HCl or 0.1 M NaOH. The WPI was used at a pH of 6.5 to avoid precipitation of the whey proteins. In all cases the maximum ionic strength would remain below 10 mM. After setting the pH, mixed systems were prepared by quickly adding a fixed weight of the stock EGCG-solution into the same weight of complexing agent (CA)-solution under continuous stirring. Thus the final samples contained 0.6 wt % EGCG and 0.6 wt % CA.

Dynamic Light Scattering (DLS)

DLS measurements were performed within 4 hours after sample preparation using a Zetasizer Nano ZS instrument (Malvern Instruments, Malvern, UK). This instrument records intensity fluctuations of scattered light at a fixed angle from clear samples containing particles between 1 and 1000 nm in size. These fluctuations are converted into an autocorrelation function spanning time scales between picoseconds and seconds. The instrument software fits intensity- and volume-weighed size distributions to the recorded autocorrelations. Samples were measured without any dilution at 25° C. The viscosity of the samples was assumed to be that of water in all cases and a refractive index of 1.59 was used in the analysis. Average particle size is quoted as volume—averaged mean particle size. Where more than one peak was present in the data, the particle size corresponding to the maximum of each peak is given.

¹H-NMR

Proton-NMR measurements were carried out on 0.6 ml samples in 5 mm NMR tubes at 27° C. using a Bruker AV600 NMR spectrometer. Prior to measurement, 5% (w/w) of D₂O was added to each sample. The spectra were acquired with presaturation of the water signal using the Bruker pulse program: noesygppr1d. A signal at ˜4.7 ppm was from residual water and was ignored for data analysis purposes. The disappearance of signals from the NMR spectrum indicates binding to form complexes. ¹H NMR spectra were obtained from a range of concentrations (0.1%-1.2%) of EGCG-solutions to demonstrate the linear response of the intensity of the EGCG peaks over this range. This calibration curve was used to estimate the amount of non-complexed (or “free”) EGCG in the samples.

Assessment of Bitterness and Astringency

The bitterness of 3 mixed systems (Pectin, WPI and PVP) containing 0.6 wt % EGCG was determined by 5 untrained individuals, who did not know the composition of the samples presented. The samples were qualitatively assessed on their bitterness and astringency.

Results

The results are shown in Table 1.

TABLE 1

| | Amount of | | | |
|---|---|---|---|---|
| | EGCG free in | | | |
| | solution | | Average | |
| Complexing | (wt % of | | Particle | |
| Agent | total EGCG) | Appearance | Size (nm) | Taste |
| WPI | <0.002 | Transparent | 7, 20 | Slightly |
| | | | | bitter + |
| | | | | astringent |
| L-proline | 100 | Transparent | 2 | N.M.* |
| Poly-L- | 0 | Transparent | 17, 73 | N.M.* |
| Proline | | | | |
| PVP 10 | 0 | White/ | >>10000 | N.M.* |
| | | Turbid | | |
| PVP 40 | 0 | White/ | 400 | Not bitter, |
| | | Turbid | | not |
| | | | | astringent |
| PVP 360 | 0 | White/ | 5000 | N.M.* |
| | | Turbid | | |
| Pectin | 47 | Transparent | 400 | Very bitter |
| | | | | and |
| | | | | astringent |

*N.M. = Not measured.

As can be seen from the data in table 1, L-proline, which is not a polymer, does not complex polyphenol (100% of the EGCG is free in solution). Pectin is a polymer but does not contain amine groups. The polymers containing amine groups (WPI and PVP) all complexed more of the polyphenol than pectin. The greatest ability to mask bitterness and astringency of polyphenol was observed with the polymers containing amine groups.

### Example 2

In this example, polyphenol-containing complexes were used as a concentrated base which was diluted to make a final product with desired concentration of polyphenols.

Materials

The same materials were used as for Example 1

Sample Preparation

A concentrated base containing 0.6 wt % EGCG and 0.6 wt % CA was prepared as described in Example 1. The concentrated based was then mixed 1:1 (by weight) with de-ionized water under high shear to facilitate mixing. The resulting product was characterized by light scattering to check if the complexes remain stable.

Dynamic Light Scattering (DLS)

Particle size determination was performed as described in Example 1.

Results

The results are shown in Table 2.

TABLE 2

| | | Average Particle |
|---|---|---|
| Complexing Agent | Appearance | Size (nm) |
| WPI | Transparent | 7, 20 |
| PVP 40 | White/Turbid | 400 |

It can be seen from the data in table 2 that the average particle size did not change upon dilution and the system remained stable.

### Example 3

In this example, the effect of the polyphenol-polymer complex on bitterness in chocolate was investigated.

Materials

Pure cocoa mass rich in polyphenols was “cocoa liquor CM Fine” from Barry Callebout Nederland BV. Polyvinylpyrrolidone was “Kolidon® 30” from BASF, Germany. All water used was domestic tap water.

Sample Preparation

A 2 wt % pvp solution was prepared by adding pvp to water and stirring at 45° C. for 10 minutes. Cocoa mass was then melted in glass jars in a waterbath at 45° C. A first sample (sample A) was then prepared by mixing the melted cocoa mass on a 1:1 weight ratio with water at 45° C. A second sample (sample B) was prepared by mixing the melted cocoa mass on a 1:1 weight ratio with the pvp solution at 45° C. 5 minutes after preparation, the samples were tasted blind by two test persons in order B and then A.

Results

Both test persons stated that chocolate B was clearly less bitter than chocolate A. Therefore, the presence of pvp in a chocolate formulation can reduce the perceived bitterness of the chocolate.

1. A composition comprising:
polyphenol; and
polymer comprising amine groups, wherein the polymer is not casein;
wherein at least 0.1% polyphenol by weight of the composition is present as part of a complex with the polymer, and wherein the complex is in the form of particles.

2. A composition according to claim 1 wherein at least 90% by weight of the particles have a particle size of less than 5000 nm.

3. A composition according to claim 1 wherein the particles are dispersed in a supporting medium.

4. A composition according to claim 1 wherein the polyphenol is selected from flavones, flavonols, flavanones, 3-hydroxyflavanones, isoflavones, neoflavonoids, flavan-3-ols, anthocyanidins, resveratrol or a mixture thereof.

5. A composition according to claim 4 wherein the polyphenol is selected from catechins, theaflavins or a mixture thereof.

6. A composition according to claim 1 wherein the weight-average molecular weight of the polymer is at least 1 kDa.

7. A composition according to claim 1 wherein the polymer is at least one of:
protein containing amino acids containing amine groups, a polypeptide containing amino acids containing amine groups, or a mixture thereof;
DNA, RNA or a mixture thereof;
poly(vinylpyridine), poly(vinylpirrolidone), polyaniline, polypyrrole, or a mixture thereof, and
polysaccharide containing amine groups.

8. A composition according to claim 7 wherein the protein is selected from gliadin, zein, collagen, gelatine, elastin, saliva proteins, whey proteins, soy proteins, their hydrosylates, their derivatives, or a mixture thereof.

9. A composition according to claim 8 wherein the protein is whey protein.

10. A composition according to claim 1 which is a food composition.

11. A composition according to claim 10 wherein the composition is a beverage, preferably a tea-based beverage.

12. A composition according to claim 10 wherein the composition is chocolate.

13. A composition according to claim 12 wherein the composition is white chocolate.

14. A composition according to claim 1 wherein the composition comprises theobromine.

15. A unit dose of a composition according to claim 1 comprising at least 50 mg total polyphenol.

16. A unit dose according to claim 15 having a mass of less than 500 g.

17. Use of a polymer comprising amine groups for reducing or eliminating bitterness and/or astringency of polyphenol, wherein the polymer is not casein.

18. Use according to claim 17 wherein at least some of the polyphenol is present as a complex with the polymer.

19. Use according to claim 18 wherein the complex is in the form of particles.

20. A method of manufacturing a composition according to claim 1 wherein the complex is formed by contacting the polymer and polyphenol in the supporting medium.

21. A method of manufacturing a composition comprising a complex of polyphenol and polymer comprising amine groups, the process comprising the steps of:
i) mixing the polyphenol and polymer thereby to form a complex;
ii) recovering the complex; and then
iii) combining the complex with a supporting medium.

22. A method according to claim 21 wherein the complex is recovered in step (ii) as particles and wherein step (iii) comprises dispersing the particles in the supporting medium.

23. A method according to claim 21 wherein the polymer is not casein.
